(19) United States
(12) Patent Application Publication
(10) Pub. No.: US 2023/0298617 A1
(43) Pub. Date: Sep. 21, 2023

(54) MESSAGE GENERATION APPARATUS, MESSAGE PRESENTATION APPARATUS, MESSAGE GENERATION METHOD, AND MESSAGE GENERATION PROGRAM

(71) Applicant: NIPPON TELEGRAPH AND TELEPHONE CORPORATION, Tokyo (JP)

(72) Inventors: Mana SASAGAWA, Musashino-shi, Tokyo (JP); Tae SATO, Musashino-shi, Tokyo (JP)

(73) Assignee: NIPPON TELEGRAPH AND TELEPHONE CORPORATION, Tokyo (JP)

(21) Appl. No.: 17/928,875

(22) PCT Filed: Jun. 8, 2020
(86) PCT No.: PCT/JP2020/022488

§ 371 Date: Nov. 30, 2022

(51) Int. Cl. G10L 25/63; H04L 51/02

(52) U.S. Cl. CPC G10L 25/63; H04L 51/02

(57) ABSTRACT

A message generation device according to an embodiment includes: a communicator information acquisition unit that acquires communicator information for estimating the emotion of a communicator; a receiver information acquisition unit that acquires receiver information for estimating the emotion of a receiver who is to receive a message from the communicator; and a message generation unit that generates a message indicating an activity that corresponds to the emotion of the communicator that was estimated based on the communicator information acquired by the communicator information acquisition unit. If the emotion of the communicator estimated based on the communicator information acquired by the communicator information acquisition unit is similar to the emotion of the receiver estimated based on the receiver information acquired by the receiver information acquisition unit, the message generation unit generates a message that specifically indicates the activity, as the message indicating the activity. If the estimated emotion of the communicator and the estimated emotion of the receiver are dissimilar, the message generation unit generates a message that conceptually indicates the activity, as the message indicating the activity.

### TECHNICAL FIELD

Embodiments of the present invention relate to a message generation device, a message presentation device, a message generation method, and a message generation program.

### BACKGROUND ART

Various techniques for presenting a message based on a communicator’s emotion have been proposed.

For example, PTL 1 discloses an emotion estimation technique for estimating a dog’s emotion based on characteristics of the dog’s bark. Products that apply this emotion estimation technique to provide tools for communication with pets are also available. With such a product, multiple messages are prepared for each of various pet emotions, and a message associated with an estimated emotion is randomly presented.

### CITATION LIST

### Patent Literature

[PTL 1] WO 2003/015076

### SUMMARY OF THE INVENTION

### Technical Problem

When a communicator asserts a desire to perform an activity, the emotions of the receiver, who is the communication partner, often determine whether the desire will be fulfilled. For example, in the case where the communicator playfully thinks “I want to take a walk!”, if the receiver’s emotion is similar to the communicator’s “playful” emotion, there is a high possibility that the receiver will perform the activity. On the other hand, if the receiver’s emotion is dissimilar to the communicator’s emotion “playful” (e.g., if the receiver is “sad”), there is a high possibility that the activity will not be performed.

PTL 1 does not disclose a configuration with consideration given to the emotions of the receiver who is the communication partner.

The present invention is directed to providing technology that makes it possible to generate a message for presentation with consideration given to not only the emotion of the communicator but also the emotion of the receiver who is the communication partner.

### Means for Solving the Problem

In order to solve the foregoing problems, a message generation device according to an aspect of the present invention includes: a communicator information acquisition unit configured to acquire communicator information for estimating an emotion of a communicator; a receiver information acquisition unit configured to acquire receiver information for estimating an emotion of a receiver who is to receive a message from the communicator; and a message generation unit configured to generate a message indicating an activity that corresponds to the emotion of the communicator that was estimated based on the communicator information acquired by the communicator information acquisition unit, wherein in a case where the emotion of the communicator estimated based on the communicator information acquired by the communicator information acquisition unit is similar to the emotion of the receiver estimated based on the receiver information acquired by the receiver information acquisition unit, the message generation unit generates a message that specifically indicates the activity, as the message indicating the activity, and in a case where the estimated emotion of the communicator and the estimated emotion of the receiver are dissimilar, the message generation unit generates a message that conceptually indicates the activity, as the message indicating the activity.

### Effects of the Invention

According to this aspect of the present invention, a message is generated in accordance with the extent of similarity of emotions between the communicator and the receiver who is the communication partner, thus making it possible to provide technology that makes it possible to generate a message for presentation with consideration given to not only the emotion of the communicator but also the emotion of the receiver.

### BRIEF DESCRIPTION OF DRAWINGS

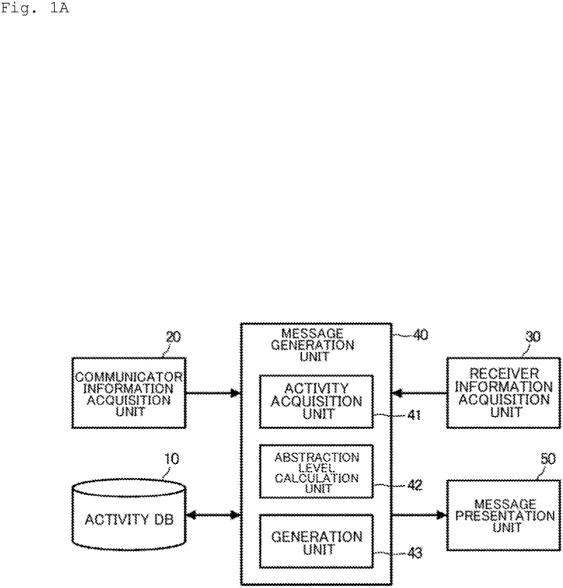

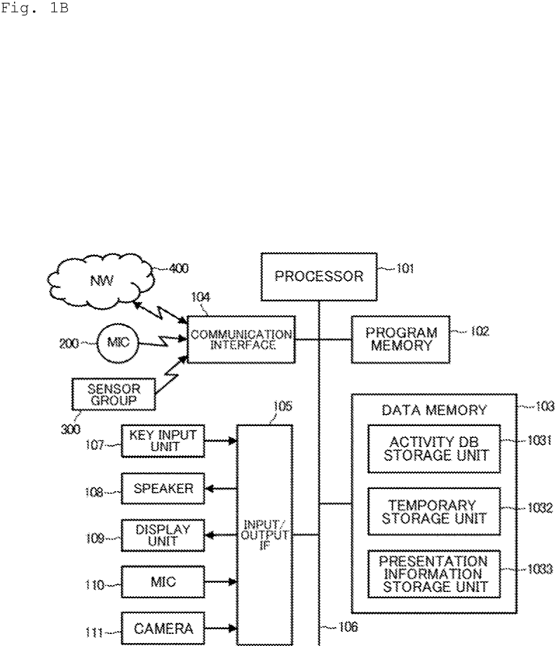

### FIG. 1

FIG. 1A is a block diagram showing an example of the configuration of a message presentation device that includes a message generation device according to a first embodiment of the present invention.

### FIG. 1B

FIG. 1B is a diagram showing an example of the hardware configuration of an information processing device that constitutes the message presentation device.

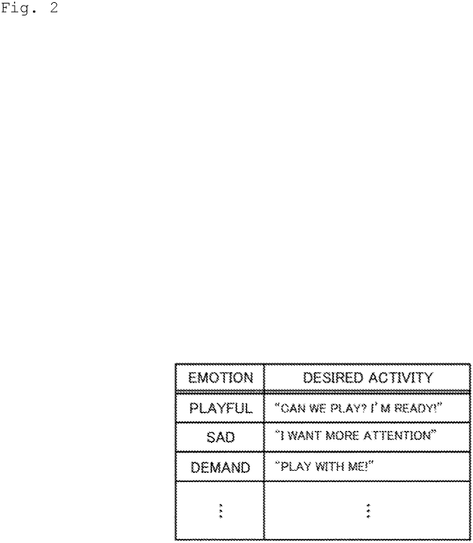

### FIG. 2

FIG. 2 is a diagram showing an example of information held by an activity database.

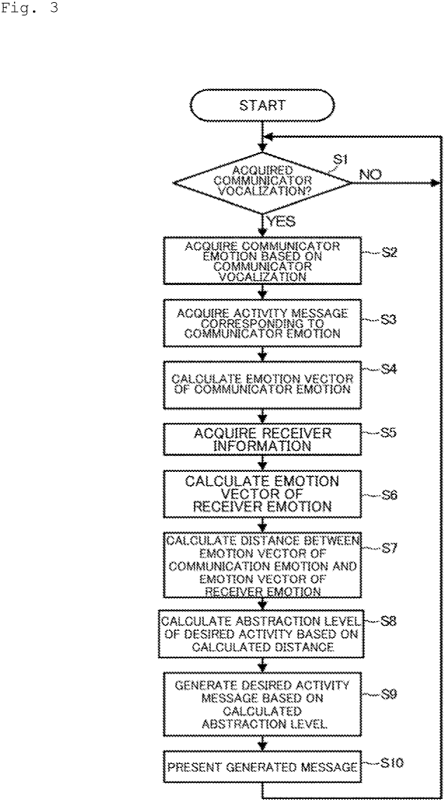

### FIG. 3

FIG. 3 is a flowchart showing an example of processing operations in the information processing device.

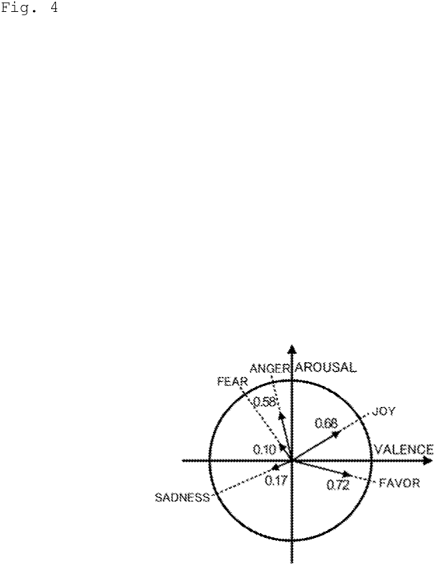

### FIG. 4

FIG. 4 is a diagram in which emotion components indicated by the activity message “Can we play? I’m ready!” are modeled in Russell’s circumplex model of affect.

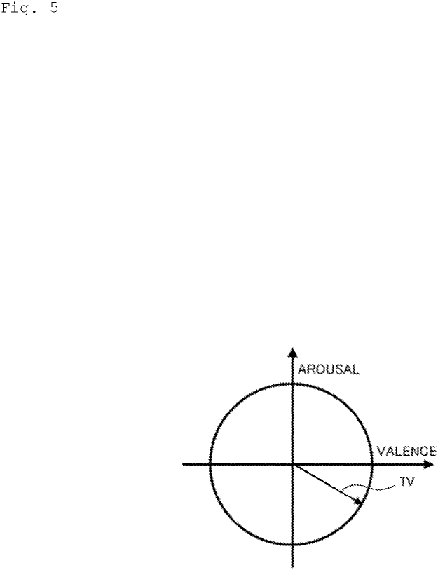

### FIG. 5

FIG. 5 is a diagram showing an emotion vector of a communicator emotion acquired based on emotion vectors in FIG. 4.

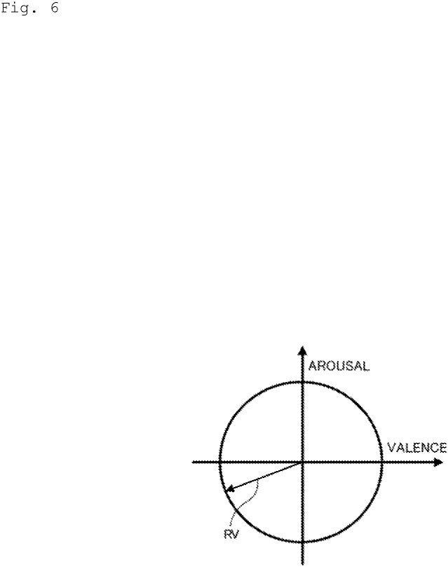

### FIG. 6

FIG. 6 is a diagram showing an emotion vector of a receiver emotion.

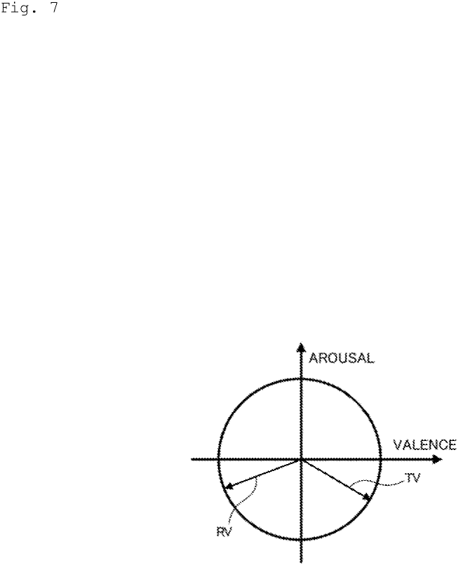

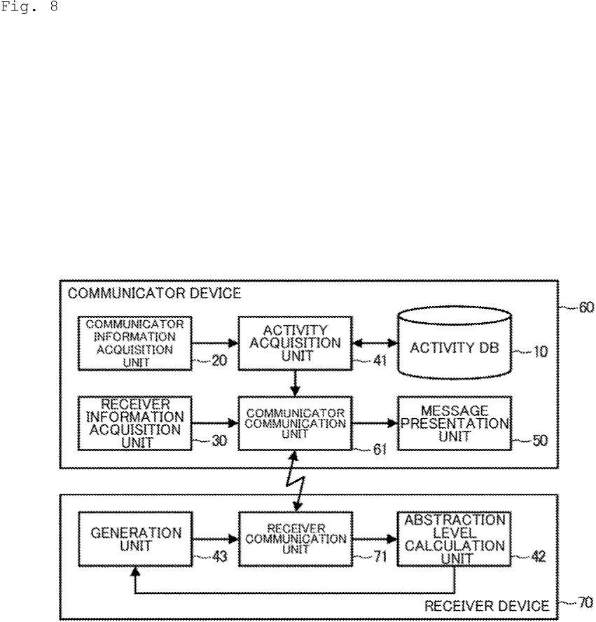

### FIG. 7

FIG. 7 is a diagram showing the relationship between emotion vectors of communicator emotions and emotion vectors of receiver emotions.

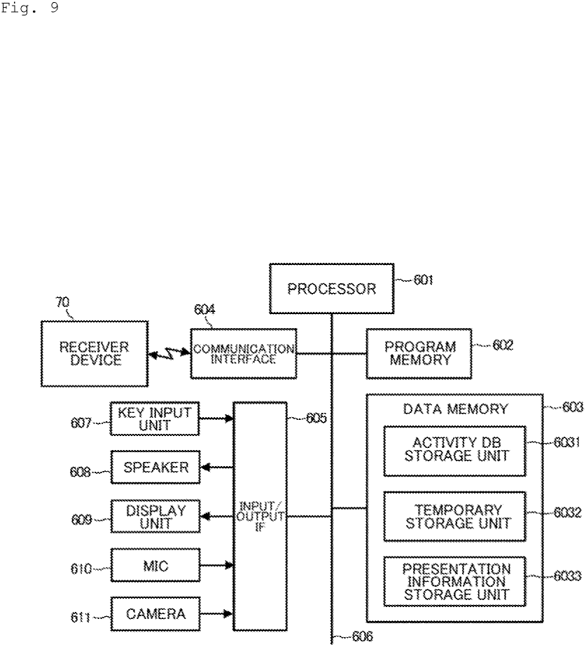

### FIG. 8

FIG. 8 is a block diagram showing an example of the configuration of a message presentation device that includes a message generation device according to a second embodiment of the present invention.

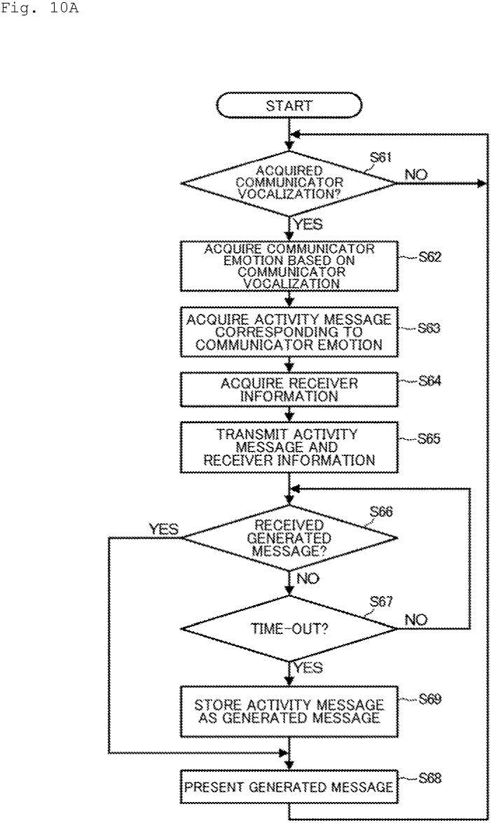

### FIG. 9

FIG. 9 is a diagram showing an example of the hardware configuration of an information processing device that constitutes a communicator device in the message presentation device shown in FIG. 8.

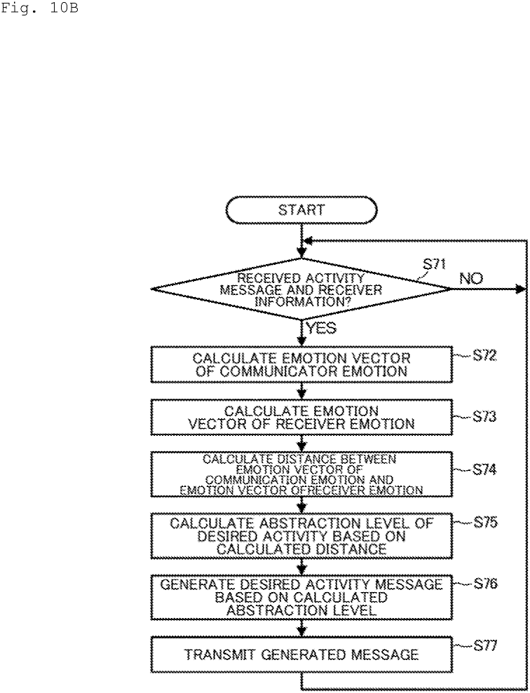

### FIG. 10A

FIG. 10A is a flowchart showing an example of processing operations in the information processing device shown in FIG. 9.

### FIG. 10B

FIG. 10B is a flowchart showing an example of processing operations in an information processing device that constitutes a receiver device in the message presentation device shown in FIG. 8.

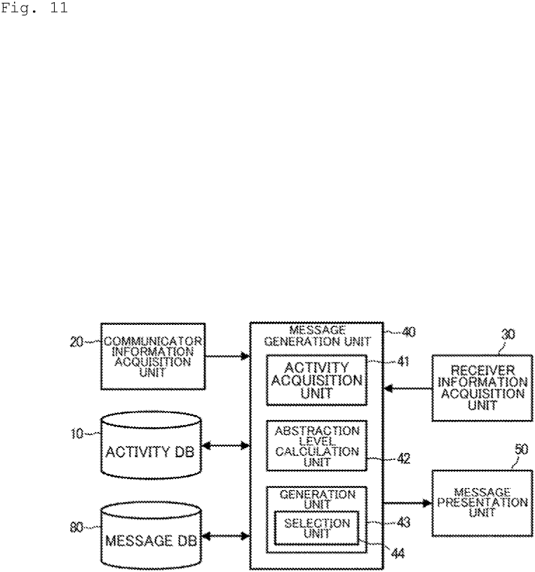

### FIG. 11

FIG. 11 is a block diagram showing an example of the configuration of a message presentation device that includes a message generation device according to a third embodiment of the present invention.

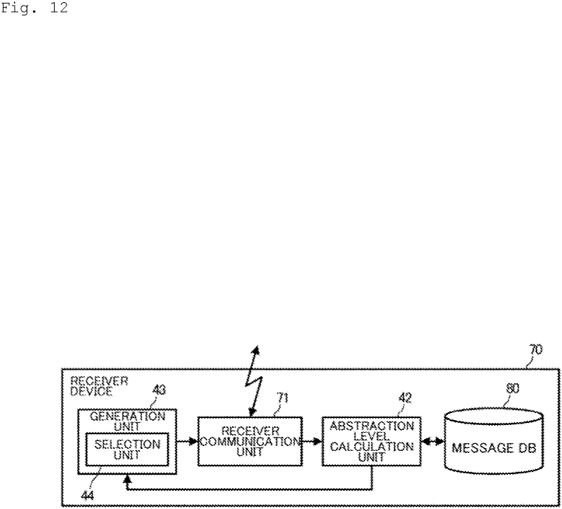

### FIG. 12

FIG. 12 is a block diagram showing the configuration of the receiver device in another example of the configuration of the message presentation device that includes the message generation device according to the third embodiment.

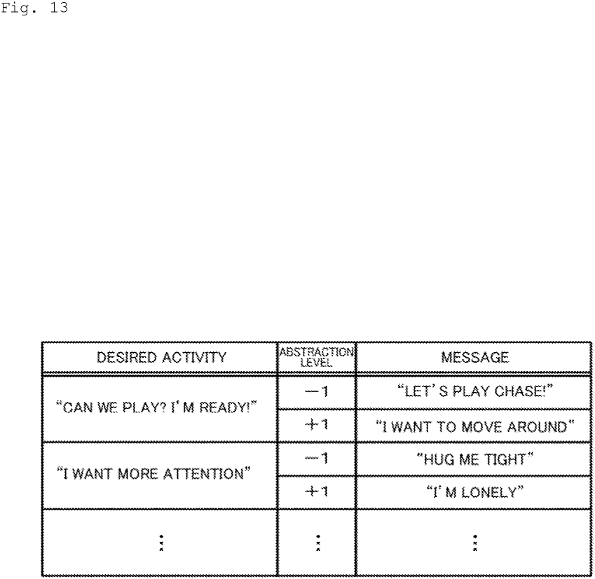

### FIG. 13

FIG. 13 is a diagram showing an example of information held in a message database in the message generation device according to the third embodiment.

### DESCRIPTION OF EMBODIMENTS

Hereinafter, embodiments of the present invention will be described with reference to the drawings.

### First Embodiment

FIG. 1A is a block diagram showing an example of the configuration of a message presentation device that includes a message generation device according to a first embodiment of the present invention. The message generation device includes an activity database 10, a communicator information acquisition unit 20, a receiver information acquisition unit 30, and a message generation unit 40. The message presentation device includes a message generation device and a message presentation unit 50. Note that in FIG. 1A, “activity database” is abbreviated as “activity DB”.

Here, the activity database 10 holds activity messages indicating activities that a communicator wants to perform, in correspondence with communicator emotions.

The communicator information acquisition unit 20 acquires communicator information for estimating an emotion of the communicator. Examples of the communicator include pets that make various calls and whines depending on their emotions, such as a dog, a cat, or a bird. The communicator may also be a human infant who is still unable to speak and expresses their emotions by crying or whining. The communicator information includes at least vocalization information about a vocalization emitted by the communicator. The communicator information can also include various types of information that can be used to estimate the emotion of the communicator, such as image information that captures the appearance of the communicator, and biometric information that indicates a biological state such as the communicator’s body temperature and heart rate.

The receiver information acquisition unit 30 acquires receiver information for estimating the emotion of the receiver who receives the message from the communicator. Examples of the receiver include pet owners and parents of human infants. The receiver information can include various types of information that can be used to estimate the emotion of the receiver, such as vocalization information regarding a vocalization made by the receiver, image information that captures the appearance of the receiver, and receiver biometric information.

The message generation unit 40 generates a message that indicates an activity corresponding to a communicator emotion estimated based on the communicator information acquired by the communicator information acquisition unit 20. The message generation unit 40 generates a message that specifically indicates an activity if there is similarity between the communicator emotion estimated based on the communicator information acquired by the communicator information acquisition unit 20 and the receiver emotion estimated based on the receiver information acquired by the receiver information acquisition unit 30. The message generation unit 40 also generates a message that conceptually indicates an activity if the estimated communicator emotion and the estimated receiver emotion are dissimilar.

More specifically, the message generation unit 40 includes an activity acquisition unit 41, an abstraction level calculation unit 42, and a generation unit 43.

The activity acquisition unit 41 estimates a communicator emotion based on the communicator information acquired by the communicator information acquisition unit 20, and acquires an activity message that indicates an activity that corresponds to the estimated communicator emotion from the activity database 10.

The abstraction level calculation unit 42 estimates a receiver emotion based on the receiver information acquired by the receiver information acquisition unit 30, and calculates an abstraction level for the message that is to be generated, based on the similarity between the estimated receiver emotion and the communicator emotion that was estimated by the activity acquisition unit 41.

The generation unit 43 generates a message based on the abstraction level generated by the abstraction level calculation unit 42.

Also, the message presentation unit 50 presents the message generated by the message generation unit 40 to the receiver.

FIG. 1B is a diagram showing an example of the hardware configuration of an information processing device that constitutes the message presentation device shown in FIG. 1A. The information processing device may be provided as a communication device that includes a dedicated housing, or may be realized by a general-purpose computer such as a smartphone or a personal computer.

As shown in FIG. 1B, the information processing device includes a hardware processor 101 such as a CPU (Central Processing Unit). In the information processing device, a program memory 102, a data memory 103, a communication interface 104, and an input/output interface 105 are connected to the processor 101 via a bus 106. Note that in FIG. 1B, “input/output interface” is abbreviated as “input/output IF”.

Here, the program memory 102 is a non-transitory tangible computer-readable storage medium that includes a non-volatile memory that can be written to and read from at any time, such as an HDD (Hard Disk Drive) or an SSD (Solid State Drive), in combination with a non-volatile memory such as a ROM (Read Only Memory). The program memory 102 stores programs necessary for the processor 101 to execute various types of control processing pertaining to the first embodiment. Specifically, processing function units in the communicator information acquisition unit 20, the receiver information acquisition unit 30, the message generation unit 40, and the message presentation unit 50 can all be realized by the processor 101 reading out and executing a program stored in the program memory 102. Note that some or all of these processing function units may be realized in various other aspects, including an integrated circuit such as an application specific integrated circuit (ASIC), a DSP (Digital Signal Processor), or an FPGA (Field-Programmable Gate Array).

Also, the data memory 103 is a tangible computer-readable storage medium that includes the above-mentioned non-volatile memory in combination with a volatile memory such as a RAM (Random Access Memory). The data memory 103 is used to store various types of data acquired and created during the execution of various types of processing. Specifically, areas for storing various types of data are appropriately secured in the data memory 103 during the execution of various types of processing. As examples of such areas, the data memory 103 may be provided with an activity database storage unit 1031, a temporary storage unit 1032, and a presentation information storage unit 1033. Note that in FIG. 1B, “activity database storage unit” is abbreviated as “activity DB storage unit”.

The activity database storage unit 1031 stores activity messages that indicate activities that the communicator wants to perform, in correspondence with communicator emotions. Specifically, the activity database 10 can be configured in the activity database storage unit 1031.

The temporary storage unit 1032 stores various types of data, such as data that is acquired or generated when the processor 101 performs operations as the communicator information acquisition unit 20, the receiver information acquisition unit 30, and the message generation unit 40, as well as communicator information, receiver information, activity messages indicating desired activities, and emotions.

The presentation information storage unit 1033 stores a message that is generated when the processor 101 performs operations as the message generation unit 40 and that is to be presented to the receiver when the processor 101 performs operations as the message presentation unit 50.

The communication interface 104 can include one or more wired or wireless communication modules.

As one example, the communication interface 104 includes a wireless communication module that utilizes short-range wireless technology such as Bluetooth (registered trademark). This wireless communication module receives vocalization signals from a wireless microphone 200, sensor signals from sensors in a sensor group 300, and the like Under control of the processor 101. Note that in FIG. 1B, “wireless microphone” is abbreviated as “MIC”. The wireless communication module can convert the received signals into information that can be processed by the processor 101, and can store such information in the temporary storage unit 1032 of the data memory 103. For example, if the wireless microphone 200 is attached to the communicator or arranged in the vicinity of the communicator, the information processing device can acquire vocalization information regarding the communicator. Also, if an image sensor such as a camera included in the sensor group 300 is arranged so as to capture images of the communicator, or if a biometric sensor such as a body temperature sensor or a heart rate sensor is attached to the communicator, the information processing device can acquire image information or biometric information regarding the communicator. In other words, the processor 101 and the communication interface 104 can function as the communicator information acquisition unit 20. Also, if a biometric sensor such as a body temperature sensor or a heartbeat sensor included in the sensor group 300 is attached to the receiver, the information processing device can acquire biometric information regarding the receiver. In other words, the processor 101 and the communication interface 104 can also function as the receiver information acquisition unit 30.

Also, the communication interface 104 may include a wireless communication module that wirelessly connects to a Wi-Fi access point or a mobile phone base station, for example. Under control of processor 101, the wireless communication module can perform communication with other information processing devices and server devices on the network 400 via Wi-Fi access points or mobile phone base stations, and transmit and receive various types of information. Note that in FIG. 1B, “network” is abbreviated as “NW”. The network 400 is constituted by an IP network including the Internet, and an access network for accessing the IP network. Examples of the access network include a public wired network, a mobile phone network, a wired LAN (Local Area Network), a wireless LAN, and a CATV (Cable Television) network.

Also, a key input unit 107, a speaker 108, a display unit 109, a microphone 110, and a camera 111 are connected to the input/output interface 105. Note that in FIG. 1B, “microphone” is abbreviated as “MIC”.

The key input unit 107 includes operation keys and buttons for allowing the receiver, who is a user of the information processing device, to give operation instructions to the processor 101. In response to operations performed on the key input unit 107, the input/output interface 105 inputs corresponding operation signals to the processor 101.

The speaker 108 generates sound in accordance with a signal received from the input/output interface 105. For example, the processor 101 converts a message stored in the presentation information storage unit 1033 into vocalization information, and the vocalization information is input to the speaker 108 as an audio signal by the input/output interface 105, and thus the message is presented to the receiver as audio. In other words, the processor 101, the input/output interface 105, and the speaker 108 can function as the message presentation unit 50.

The display unit 109 is a display device that uses a liquid crystal display, an organic EL (Electro Luminescence) display, or the like and displays images that correspond to signals received from the input/output interface 105. For example, the processor 101 converts the message stored in the presentation information storage unit 1033 into image information, and the image information is input to the display unit 109 as an image signal by the input/output interface 105, and thus the message can be presented to the receiver as an image. In other words, the processor 101, the input/output interface 105, and the display unit 109 can function as the message presentation unit 50. Note that the key input unit 107 and the display unit 109 may be configured as an integrated device. Specifically, it may be a so-called tablet input/display device in which an electrostatic-capacitance or pressure-sensitive input detection sheet is arranged on the display screen of a display device.

The microphone 110 collects nearby sounds and inputs them as an audio signal to the input/output interface 105. Under control of the processor 101, the input/output interface 105 converts the received audio signal into vocalization information and stores it in the temporary storage unit 1032. If the information processing device is located near the receiver such as in the case of being a smartphone, the microphone 110 collects vocalizations emitted by the receiver. Therefore, the processor 101 and the input/output interface 105 can function as the receiver information acquisition unit 30. Also, if the distance between the receiver and the communicator is short and the microphone 110 can collect vocalizations from both the receiver and the communicator, the processor 101 and the input/output interface 105 can function as the communicator information acquisition unit 20. For example, using a feature quantity of the frequency or the like of the vocalization information, the processor 101 can handle the vocalization information as sentence information and perform speech recognition to obtain the meaning to some extent, and under some conditions can determine whether the vocalization information is receiver information or communicator information.

The camera 111 captures images in the field of view and inputs a captured image signal to the input/output interface 105. Under control of the processor 101, the input/output interface 105 converts the received captured image signal into image information and stores the image information in the temporary storage unit 1032. If the receiver is in the field of view of the camera 111, the processor 101 and the input/output interface 105 can function as the receiver information acquisition unit 30 that acquires receiver image information. Also, if the communicator is in the field of view of the camera 111, the processor 101 and the input/output interface 105 can function as the communicator information acquisition unit 20 that acquires communicator image information. The processor 101 can determine whether image information is receiver information or the communicator information based on a feature quantity of the image information, for example.

The input/output interface 105 may have a function for reading from and writing to a recording medium such as a semiconductor memory (e.g., a flash memory), or may have a function for connection to a reader/writer having a function for reading from and writing to such a recording medium. As a result, a recording medium that can be mounted to and removed from the information processing device can be used as an activity database storage unit that stores activity messages regarding desired activities. The input/output interface 105 may further have a function for connection with other devices.

FIG. 2 is a diagram showing an example of information held by the activity database 10 configured in the activity database storage unit 1031. This is an example in the case where the communicator is a dog and the receiver is a human. As shown in FIG. 2, the activity database 10 stores activity messages that indicate activities desired by the dog, which is the communicator, in correspondence with emotions such as “playful”, “sad”, and “demand”. For example, in the activity database 10, the activity message “Can we play? I’m ready!” is stored in correspondence with the emotion “playful”, and the activity message “I want more attention” is stored in correspondence with the emotion “sad”.

Next, operations of the message presentation device that includes the message generation device will be described. The case where the communicator is a dog and the receiver is a human is described in the following example.

FIG. 3 is a flowchart showing an example of processing operations in the message presentation device. This flowchart shows processing operations in the processor 101 of the information processing device that functions as the communicator information acquisition unit 20, the receiver information acquisition unit 30, the message generation unit 40, and the message presentation unit 50 of the message presentation device. For example, if the wireless microphone 200 is attached to the dog, which is the communicator, or in the vicinity thereof and then an instruction for starting message presentation is received from the key input unit 107 via the input/output interface 105, the processor 101 starts to perform the operations shown in the aforementioned flowchart. Note that the sensor group 300 that includes an image sensor, a biometric sensor, and the like may be used in addition to the wireless microphone 200, but in this example, the dog’s emotion is estimated using only the dog’s bark as communicator information.

First, the processor 101 functions as the communicator information acquisition unit 20 and determines whether or not a communicator vocalization collected by the wireless microphone 200, that is to say dog’s bark, has been acquired by the communication interface 104 (step S1). Here, if it is determined that a communicator vocalization has not been acquired (NO in step S1), the processor 101 repeats the processing of step S1.

On the other hand, if it is determined that a communicator vocalization has been acquired (YES in step S1), the processor 101 stores the acquired communicator vocalization in the temporary storage unit 1032 and performs operations as the activity acquisition unit 41 of the message generation unit 40.

Specifically, first, the processor 101 acquires a communicator emotion, that is to say the dog’s emotion, based on the communicator vocalization stored in the temporary storage unit 1032 (step S2). There are no particular limitations on the method used to acquire the communicator emotion in this embodiment. For example, the emotion of the dog can be obtained using the method as disclosed in PTL 1.

The processor 101 then acquires, from the activity database 10 stored in the activity database storage unit 1031, the activity message that indicates the desired activity of the dog that corresponds to the acquired communicator emotion, and stores the acquired activity message in the temporary storage unit 1032 (step S3).

Subsequently, the processor 101 performs operations as the abstraction level calculation unit 42.

Specifically, first, the processor 101 calculates an emotion vector of the communicator emotion based on the activity message stored in the temporary storage unit 1032 (step S4). The emotion vector is a vector on Russell’s circumplex model of affect. Russell’s circumplex model of affect is a model that maps emotions in a two-dimensional space centered on valence and arousal. Russell’s circumplex model of affect is disclosed in “J. A. Russell, ‘A circumplex model of affect’, Journal of Personality and Social Psychology, vol.39, no.6, p.1161, 1980”, for example.

In this emotion vector calculation processing, the processor 101 first calculates the ratios of emotion components in the communicator emotion indicated by the activity message for the desired activity. There are no particular limitations on the method for calculating the ratios of emotion components in this embodiment. For example, the ratios of emotion components can be calculated by an emotion component ratio calculating algorithm stored in the program memory 102 or the data memory 103. Text emotion recognition AI (e.g., https://emotion-ai.userlocal.jp/) is also available on the Internet as existing technology. In the case of using an emotion recognition resource provided on some sort of site on the Internet for calculating the ratios of emotion components in text, the processor 101 transmits, via the communication interface 104, the text of the message to a specified site on the network 400 that provides that resource. Accordingly, the processor 101 can receive emotion component ratio data corresponding to the transmitted text from the specified site.

For example, in the case of the activity message “Can we play? I’m ready!” that corresponds to the emotion “playful” shown in FIG. 2, the processor 101 calculates joy=0.68, favor=0.72, fear=0.10, sadness=0.17, and anger=0.58 as the ratios of emotion components.

Next, the processor 101 converts the calculated emotion components into an emotion vector for each message. FIG. 4 is a diagram in which emotion components indicated by the activity message “Can we play? I’m ready!” are modeled in Russell’s circumplex model of affect. In Russell’s circumplex model of affect, on the valence axis, the degree of “pleasure” increases rightward and the degree of “misery” increases leftward. On the arousal axis, the degree of “arousal” increases upward and the degree of “sleepiness” increases downward. Each component of emotion is represented as a direction away from the origin in Russell’s circumplex model of affect. For each vector in Russell’s circumplex model of affect calculated by the processor 101, the magnitude of the vector (min0 to MAX1) is the calculated emotion ratio, and the direction of the vector is the direction, from the origin, to which the emotion was mapped.

The processor 101 then acquires an emotion vector of the communicator emotion by obtaining the sum of the emotion vectors of the emotion components. Concepts regarding emotion vectors and resultant force in Russell’s circumplex model of affect are disclosed in “Reiko Ariga, Junji Watanabe, Junji Nunobiki, ‘Impression evaluation of emotional expressions of agents in response to expansion and contraction of graphic’, Human Interface Symposium 2017, Proceedings (2017)”, for example. FIG. 5 is a diagram showing an emotion vector TV acquired based on the emotion vectors in FIG. 4 for the activity message “Can we play? I’m ready!” indicating the desired activity that corresponds to the emotion of the dog that is the communicator.

After the emotion vector of the communicator emotion has been calculated in this way, the processor 101 then also calculates an emotion vector for the emotion of the human being who is the receiver.

To achieve this, the processor 101 acquires receiver information as the receiver information acquisition unit 30 (step S5). For example, as the receiver information, a receiver vocalization collected by the microphone 110 and/or a face image of the human receiver captured by the camera 111 is stored in the temporary storage unit 1032 by the processor 101 via the input/output interface 105.

The processor 101 then returns to performing operations as the abstraction level calculation unit 42, and calculates an emotion vector of the receiver emotion (step S6). Hereinafter, the emotion of the human being who is the receiver will be referred to as the “receiver emotion”.

Specifically, first, the processor 101 calculates the ratios of emotion components of the person who is the receiver based on the vocalization and/or the face image stored in the temporary storage unit 1032. There are also no particular limitations on the method for calculating the ratios of emotion components of the receiver in this embodiment. For example, a technique for calculating the ratios of emotion component based on a vocalization or a face image is disclosed in “Panagiotis Tzirakis, George Trigeorgis, Mihalis A. Nicolaou, Bjorn W. Schuller, Stefanos Zafeiriou, ‘End-to-End Multimodal Emotion Recognition Using Deep Neural Networks’, IEEE Journal of Selected Topics in Signal Processing, vol.11, no.8, pp.1301-1309, 2017″. The processor 101 can calculate the ratios of emotion components using an emotion component ratio calculation algorithm stored in the program memory 102 or the data memory 103. Facial expression emotion recognition AI (e.g., https://emotionai.userlocal.jp/face) is also available on the Internet as existing technology. In the case of using an emotion recognition resource provided on some sort of site on the Internet for calculating the ratios of emotion components based on an expression, the processor 101 transmits, via the communication interface 104, the face image to a specified site on the network 400 that provides that resource. Accordingly, the processor 101 can receive emotion component ratio data corresponding to the transmitted face image from the specified site.

Next, the processor 101 converts the calculated receiver emotion components into an emotion vector. The processor 101 then acquires an emotion vector of the receiver emotion by obtaining the sum of the emotion vectors of the emotion components. FIG. 6 is a diagram showing an emotion vector RV of the acquired receiver emotion.

After the emotion vector TV of the communicator emotion and the emotion vector RV of the receiver emotion have been calculated in this way, the processor 101 calculates the distance between the emotion vector TV of the communicator emotion and the emotion vector RV of the receiver emotion (step S7). For example, the processor 101 can obtain this distance by calculating the inner product of the communicator emotion vector TV and the receiver emotion vector RV.

The processor 101 then calculates an abstraction level for the desired activity of the dog, which is the communicator, based on the calculated distance (step S8). For example, in the case where the distance is obtained using the inner product, if the inner product is “-1” or more and less than “0”, the processor 101 determines that the communicator emotion and the receiver emotion are dissimilar from each other, and raises the abstraction level by one level. If the inner product is “0” or more and “1” or less, the processor 101 determines that the communicator emotion and the receiver emotion are similar to each other, and lowers the abstraction level by one level. FIG. 7 is a diagram showing the relationship between the emotion vector TV of the communicator emotion shown in FIG. 5 and the emotion vector RV of the receiver emotion shown in FIG. 6. In this example, the angle formed by the two vectors is 90 degrees or more, and the inner product is “-1” or more and less than “0”, and therefore the processor 101 determines that the communicator emotion and the receiver emotion are dissimilar from each other, and raises the abstraction level by one level. The processor 101 stores the calculated abstraction level in the temporary storage unit 1032.

Next, the processor 101 functions as the generation unit 43 and generates a message that indicates the desired activity based on the calculated abstraction level (step S9). There are no particular limitations on the message generation method in this embodiment. Also, a technique for searching for more broad/specific concepts by selecting hypo/hypernyms of an input word in a concept dictionary (dictionary + thesaurus) called WordNet (https://wordnet.princeton.edu/) is provided on the Internet as existing technology. In the case of using a concept dictionary resource provided on some sort of site on the Internet for conversion of input text in accordance with an abstraction level, the processor 101 transmits, to a specified site on the network 400 that provides that resource, the activity message that indicates the desired activity of the dog, which is the communicator, stored in the temporary storage unit 1032 and the abstraction level that corresponds to similarity between the communicator emotion and the receiver emotion, via the communication interface 104. Accordingly, the processor 101 can receive a message that corresponds to the transmitted information from the specified site. For example, in the case of transmitting the activity message “Can we play? I’m ready!” for the desired activity and the abstraction level “+1” that indicates a one level increase in the abstraction level, it is possible to receive the message “I want to move around”, which is a broader concept of “Can we play? I’m ready!”. The processor 101 stores the received message in the presentation information storage unit 1033 as a generated message.

After the message has been generated in this way, the processor 101 functions as the message presentation unit 50 and presents the generated message (step S10). Specifically, the processor 101 presents the message stored in the presentation information storage unit 1033 by, via the input/output interface 105, outputting the message as audio with use of the speaker 108 or outputting the message as an image to the display unit 109.

Subsequently, the processor 101 repeats the processing from step S1.

A message generation device according to the first embodiment described above includes: a communicator information acquisition unit 20 configured to acquire communicator information for estimating an emotion of a communicator; a receiver information acquisition unit 30 configured to acquire receiver information for estimating an emotion of a receiver who is to receive a message from the communicator; and a message generation unit 40 configured to generate a message indicating an activity that corresponds to the emotion of the communicator that was estimated based on the communicator information acquired by the communicator information acquisition unit 20, wherein in a case where the emotion of the communicator estimated based on the communicator information acquired by the communicator information acquisition unit 20 is similar to the emotion of the receiver estimated based on the receiver information acquired by the receiver information acquisition unit 30, the message generation unit 40 generates a message that specifically indicates the activity, as the message indicating the activity, and in a case where the estimated emotion of the communicator and the estimated emotion of the receiver are dissimilar, the message generation unit 40 generates a message that conceptually indicates the activity, as the message indicating the activity. Accordingly, a message is generated in accordance with the similarity of emotions between the communicator and the receiver, who is the communication partner, and therefore it is possible to generate a message for presentation with consideration given to the emotions of the receiver in addition to the emotions of the communicator.

Also, the message generation device according to the first embodiment further includes: an activity database storage unit 10 configured to hold a plurality of activity messages each indicating an activity desired by the communicator in correspondence with a communicator emotion, wherein the message generation unit 40 includes: an activity acquisition unit 41 configured to estimate the emotion of the communicator based on the communicator information acquired by the communicator information acquisition unit 20, and acquire, from the activity database 10, an activity message indicating an activity that corresponds to the estimated emotion of the communicator; an abstraction level calculation unit 42 configured to estimate the emotion of the receiver based on the receiver information acquired by the receiver information acquisition unit 30, and calculate an abstraction level of a message to be generated, in accordance with similarity between the estimated emotion of the receiver and the emotion of the communicator estimated by the activity acquisition unit 41; and a generation unit 43 configured to generate a message that corresponds to the activity message acquired by the activity acquisition unit 41, based on the abstraction level generated by the abstraction level calculation unit 42. In this way, the message generation device according to the first embodiment estimates the emotion of the communicator and the emotion of the receiver, adjusts the abstraction level of the desired activity of the communicator according to the similarity/dissimilarity between the emotions, and then generates a message for presentation. For example, if the emotions are similar to each other, the abstraction level of the desired activity is lowered when generating the message, whereas if the emotions are dissimilar, the abstraction level of the desired activity is raised when generating the message. Accordingly, even if the receiver emotion is dissimilar from the communicator emotion, by raising the abstraction level of the desired activity and expanding the range of activity options, it is possible to increase the possibility that the receiver will perform the activity. For example, when the communicator is in a playful mood and wants to play, it is possible to present the message “I want to move around”, which is a broader concept of playing, instead of the activity message “Can we play? I’m ready!”, and therefore the receiver can choose an activity that suits their mood, such as throwing a toy for exercise instead of playing with the communicator. Accordingly, win-win communication can be realized with each other, and an improvement in communication is expected.

Also, in the message generation device according to the first embodiment, the abstraction level calculation unit 42 converts the emotion of the communicator estimated by the activity acquisition unit 41 into a communicator emotion vector, converts the emotion of the receiver estimated based on the receiver information into a receiver emotion vector, and uses distance between the communicator emotion vector and the receiver emotion vector as similarity between the emotion of the communicator and the emotion of the receiver. In this way, by converting the emotions of both the communicator and the receiver into emotion vectors, it is possible to compare their emotions and simplify message selection.

Also, in the message generation device according to the first embodiment, the abstraction level calculation unit 42 calculates an inner product of the communicator emotion vector and the receiver emotion vector, in a case where the inner product is -1 or more and less than 0, the abstraction level calculation unit 42 determines that the emotion of the communicator and the emotion of the receiver are dissimilar and raises the abstraction level by one level, and in a case where the inner product is 0 or more and 1 or less, the abstraction level calculation unit 42 determines that the emotion of the communicator and the emotion of the receiver are similar and lowers the abstraction level by one level. Accordingly, the abstraction level calculation unit 42 can easily obtain the abstraction level in accordance with the extent of similarity between the emotions of the communicator and the receiver.

Also, in the message generation device according to the first embodiment, based on the activity message acquired by the activity acquisition unit 41 and the abstraction level calculated by the abstraction level calculation unit 42, the generation unit 43 generates a message indicating a more specific concept of the activity message as the message that specifically indicates the activity, or generates a message indicating a broader concept of the activity message as the message that conceptually indicates the activity. Accordingly, the generation unit 43 can generate a message in accordance with the desired activity of the communicator and the abstraction level.

Note that in the message generation device according to the first embodiment, the communicator emotion vector and the receiver emotion vector can each be a vector in Russel’s circumplex model of affect in which emotions are mapped in a two-dimensional space defined by a valence axis and an arousal axis.

Also, the message presentation device according to the first embodiment includes the message generation device according to the first embodiment; and a message presentation unit 50 configured to present, to the receiver, the message generated by the message generation unit 40 of the message generation device. Accordingly, it is possible to present a message with consideration given to the receiver emotion in addition to the communicator emotion, and with the message presentation device according to the first embodiment, even if the receiver emotion is dissimilar from the communicator emotion, it is possible to increase the possibility that the receiver will perform an activity that is similar to the activity that the communicator wants to perform.

### Second Embodiment

In the first embodiment, the message presentation device that includes the message generation device is configured as one device operated by the receiver. However, the message generation device or the message presentation device may be provided as a system divided into a plurality of devices.

FIG. 8 is a block diagram showing an example of the configuration of a message presentation device that includes a message generation device according to a second embodiment of the present invention. As shown in FIG. 8, the message presentation device is constituted by two devices, namely a communicator device 60 in possession of the communicator and a receiver device 70 in possession of the receiver.

The communicator device 60 includes an activity database 10, a communicator information acquisition unit 20, a receiver information acquisition unit 30, an activity acquisition unit 41 of a message generation unit 40, and a message presentation unit 50, which are similar to the corresponding units described in the first embodiment. The communicator device 60 further includes a communicator communication unit 61 that exchanges data with the receiver device 70. In the second embodiment, the communicator device 60 is envisioned to be a communication device for attachment to the collar of a pet such as a dog.

The receiver device 70 includes the abstraction level calculation unit 42 and the generation unit 43 of the message generation unit 40, which are similar to the corresponding units described in the first embodiment. The receiver device 70 further includes a receiver communication unit 71 that exchanges data with the communicator device 60. In the second embodiment, the receiver device 70 is envisioned to be a smartphone or a personal computer in possession of a person who is the owner of a pet such as a dog.

FIG. 9 is a diagram showing an example of the hardware configuration of an information processing device that constitutes the communicator device 60 in the message presentation device shown in FIG. 8. As shown in FIG. 9, the information processing device includes a hardware processor 601 as well as a program memory 602, a data memory 603, a communication interface 604, and an input/output interface 605 that are connected to the processor 601 via a bus 606. Note that in FIG. 9, “input/output interface” is abbreviated as “input/output IF”.

Here, the program memory 602 is a non-transitory tangible computer-readable storage medium that includes a non-volatile memory that can be written to and read from at any time, such as an HDD or an SSD, in combination with a non-volatile memory such as a ROM. The program memory 602 stores programs necessary for the processor 601 to execute various types of control processing pertaining to the second embodiment. Specifically, processing function units in the communicator information acquisition unit 20, the receiver information acquisition unit 30, the activity acquisition unit 41, the message presentation unit 50, and the communicator communication unit 61 can all be realized by the processor 601 reading out and executing a program stored in the program memory 602. Note that some or all of these processing function units may be realized in various other aspects, including an integrated circuit such as an ASIC, a DSP, or an FPGA.

Also, the data memory 603 is a tangible computer-readable storage medium that includes the above-mentioned non-volatile memory in combination with a volatile memory such as a RAM. The data memory 603 is used to store various types of data acquired and created during the execution of various types of processing. Specifically, areas for storing various types of data are appropriately secured in the data memory 603 during the execution of various types of processing. As examples of such areas, the data memory 603 may be provided with an activity database storage unit 6031, a temporary storage unit 6032, and a presentation information storage unit 6033. Note that in FIG. 9, “activity database storage unit” is abbreviated as “activity DB storage unit”.

The activity database storage unit 6031 stores activity messages that indicate activities that the communicator wants to perform, in correspondence with communicator emotions. Specifically, the activity database 10 can be configured in the activity database storage unit 6031.

The temporary storage unit 6032 stores various types of data, such as data that is acquired or generated when the processor 601 performs operations as the communicator information acquisition unit 20, the receiver information acquisition unit 30, and the activity acquisition unit 41, as well as communicator information, receiver information, activity messages indicating desired activities, and emotions.

The presentation information storage unit 6033 stores messages that are to be presented to the receiver when the processor 601 performs operations as the message presentation unit 50.

As one example, the communication interface 604 includes a wireless communication module that utilizes short-range wireless technology such as Bluetooth. This wireless communication module performs wireless data communication with the receiver device 70 Under control of the processor 601. In other words, the processor 601 and the communication interface 604 can function as the communicator communication unit 61.

Also, a key input unit 607, a speaker 608, a display unit 609, a microphone 610, and a camera 611 are connected to the input/output interface 605. Note that in FIG. 9, “microphone” is abbreviated as “MIC”.

The key input unit 607 includes buttons and operation keys such as a power key for causing the communicator device 60 to start operating. The input/output interface 605 inputs operation signals to the processor 601 in accordance with operations performed on the key input unit 607.

The speaker 608 generates sound in accordance with a signal received from the input/output interface 605. For example, the processor 601 converts a message stored in the presentation information storage unit 6033 into audio information, and the audio information is input to the speaker 608 as an audio signal by the input/output interface 605, and thus the message is presented to the receiver as audio. In other words, the processor 601, the input/output interface 605, and the speaker 608 can function as the message presentation unit 50.

The display unit 609 is a display device that uses a liquid crystal display, an organic EL display, or the like, and displays images that correspond to signals received from the input/output interface 605. For example, the processor 601 converts the message stored in the presentation information storage unit 6033 into image information, and the image information is input to the display unit 609 as an image signal by the input/output interface 605, and thus the message can be presented to the receiver as an image. In other words, the processor 601, the input/output interface 605, and the display unit 609 can function as the message presentation unit 50.

The microphone 610 collects nearby sounds and inputs them as an audio signal to the input/output interface 605. Under control of the processor 601, the input/output interface 605 converts the received audio signal into vocalization information and stores it in the temporary storage unit 6032. The microphone 610 collects vocalizations emitted by the communicator and the receiver. Accordingly, the processor 601 and the input/output interface 605 can function as the communicator information acquisition unit 20 and the receiver information acquisition unit 30.

The camera 611 captures images in the field of view and inputs a captured image signal to the input/output interface 605. Under control of the processor 601, the input/output interface 605 converts the received captured image signal into image information and stores the image information in the temporary storage unit 6032. When the communicator device 60 is attached to the communicator, if the camera 611 is attached so as to captures images ahead of the communicator, the camera 611 can capture images of the receiver. Accordingly, the processor 601 and the input/output interface 605 can function as the receiver information acquisition unit 30 for acquiring receiver image information.

The input/output interface 605 may have a function for reading from and writing to a recording medium such as a semiconductor memory (e.g., a flash memory), or may have a function for connection to a reader/writer having a function for reading from and writing to such a recording medium. As a result, a recording medium that can be mounted to and removed from the information processing device can be used as an activity database storage unit that stores activity messages indicating desired activities of the communicator in correspondence with communicator emotions. The input/output interface 605 may further have a function for connection with other devices such as a biosensor that detects biometric information of the communicator.

Also, the information processing device that constitutes the receiver device 70 may have the hardware configuration shown in FIG. 1B described in the first embodiment. However, the activity database storage unit 1031 is not required in the data memory 103. The program memory 102 stores programs necessary for the processor 101 to execute various types of control processing pertaining to the second embodiment. Specifically, processing function units in the abstraction level calculation unit 42, the generation unit 43, and the receiver communication unit 71 can all be realized by the processor 101 reading out and executing a program stored in the program memory 102.

Next, operations of the message presentation device that includes the message generation device according to the present embodiment will be described.

FIG. 10A is a flowchart showing an example of processing operations in the information processing device that constitutes the communicator device 60 in the message presentation device. This flowchart shows processing operations in the processor 601 of the information processing device that functions as the communicator information acquisition unit 20, the receiver information acquisition unit 30, the activity acquisition unit 41, the message presentation unit 50, and the communicator communication unit 61 of the communicator device 60. For example, if the communicator device 60 is attached to the communicator (e.g., is attached to a dog’s collar or the like) and then an instruction to start message presentation is given via the input/output interface 605 due to an ON operation performed on the power key of the key input unit 607, the processor 601 starts the operations shown in this flowchart.

First, the processor 601 functions as the communicator information acquisition unit 20 and determines whether or not a communicator vocalization collected by the wireless microphone 610, that is to say dog’s bark, has been acquired by the input/output interface 605 (step S61). Here, if it is determined that a communicator vocalization has not been acquired (NO in step S61), the processor 601 repeats the processing of step S61.

On the other hand, if it is determined that a communicator vocalization has been acquired (YES in step S61), the processor 601 stores the acquired communicator vocalization in the temporary storage unit 6032 and performs operations as the activity acquisition unit 41.

Specifically, first, the processor 601 acquires a communicator emotion, such as a dog emotion, based on the communicator vocalization stored in the temporary storage unit 6032 (step S62). There are no particular limitations on the method used to acquire the communicator emotion in this embodiment.

The processor 601 then acquires, from the activity database 10 stored in the activity database storage unit 6031, the activity message that indicates the desired activity of the dog that corresponds to the acquired communicator emotion, and stores the acquired activity message in the temporary storage unit 6032 (step S63).

Next, the processor 601 functions as the receiver information acquisition unit 30 to acquire receiver information (step S64). For example, as the receiver information, a receiver vocalization collected by the microphone 610 and/or a face image of the human receiver captured by the camera 611 is stored in the temporary storage unit 6032 by the processor 601 via the input/output interface 605.

Subsequently, the processor 601 performs operations as the communicator communication unit 61.

Specifically, first, the processor 601 transmits the activity message and the receiver information stored in the temporary storage unit 6032 to the receiver device 70 by the communication interface 604 (step S65).

The processor 601 then determines whether or not a generated message was received from the receiver device 70 by the communication interface 604 (step S66). Here, if it is determined that a generated message has not been received (NO in step S66), the processor 601 determines whether or not a time-out has occurred, that is to say whether or not a preset time has elapsed (step S67). If a time-out has not yet occurred (NO in step S67), the processor 601 repeats the processing from step S66. Note that the preset time is determined based on the time required for the processing of generating a message in the receiver device 70.

FIG. 10B is a flowchart showing an example of processing operations in the information processing device that constitutes the receiver device 70 in the message presentation device. This flowchart shows processing operations in the processor 101 of the information processing device that functions as the abstraction level calculation unit 42, the generation unit 43, and the receiver communication unit 71 of the receiver device 70. For example, when the start of message presentation is instructed by the key input unit 107 via the input/output interface 105, the processor 101 reads out a program stored in the program memory 602 and starts the operations shown in this flowchart.

First, the processor 101 functions as the receiver communication unit 71 and determines whether or not an activity message and receiver information have been received from the communicator device 60 by the communication interface 104 (step S71). Here, if it is determined that an activity message and receiver information have not been received (NO in step S71), the processor 101 repeats the processing of step S71.

On the other hand, if it is determined that an activity message and receiver information have been received (YES in step S71), the processor 101 stores the received activity message and receiver information in the temporary storage unit 1032, and then performs operations as the abstraction level calculation unit 42.

Specifically, first, the processor 101 calculates an emotion vector of the communicator emotion based on the activity message stored in the temporary storage unit 1032 (step S72).

The processor 101 calculates an emotion vector of the receiver emotion based on vocalization information and/or a face image that constitutes the receiver information stored in the temporary storage unit 1032 (step S73).

After calculating the emotion vector of the communicator emotion and the emotion vector of the receiver emotion in this way, the processor 101 performs operations as the generation unit 43.

Specifically, first, the processor 101 calculates the distance between the emotion vector of the communicator emotion and the emotion vector of the receiver emotion (step S74) .

The processor 101 then calculates an abstraction level for the desired activity of the dog, which is the communicator, based on the calculated distance (step S75).

Next, the processor 101 functions as the generation unit 43 and generates a message that indicates a desired activity based on the calculated abstraction level (step S76). There are no particular limitations on the message generation method in this embodiment. The processor 101 stores the generated message in the presentation information storage unit 1033.

After the message that indicates the desired activity of the dog, which is the communicator, has been generated in this way, the processor 101 functions again as the receiver communication unit 71 and transmits the message stored in the presentation information storage unit 1033 to the communicator device 60 as the generated message (step S77) .

The processor 101 then repeats the processing from step S71.

The communicator device 60 receives the generated message from the receiver device 70 via the communication interface 604 and stores the generated message in the presentation information storage unit 6033. Accordingly, the processor 601 determines that a selected message has been received (YES in step S66). The processor 601 then functions as the message presentation unit 50 and presents the generated message stored in the presentation information storage unit 6033 by, via the input/output interface 605, outputting the message as audio with use of the speaker 608 or outputting the message as an image to the display unit 609.

Subsequently, the processor 601 repeats the processing from step S61.

On the other hand, if a time-out occurs before a generated message is received from the receiver device 70 (YES in step S67), the processor 601 acquires an activity message from the temporary storage unit 6032 and stores the acquired activity message in the presentation information storage unit 6033 as the generated message (step S69). Subsequently, the processor 601 moves to the processing of step S68 and presents the generated message, which is the above-described activity message.

The message generation device according to the second embodiment described above includes a communicator device 60 in possession of the communicator and a receiver device 70 in possession of the receiver, and the receiver device 70 includes at least the abstraction level calculation unit 42 and the generation unit 43 of the message generation unit 40. In this way, the portions that require high-performance and high-speed processing functionality are implemented in a smartphone or personal computer that includes a high-performance processor 101, and thus a low-functionality processor can be used as the processor 601 of the communicator device 60, and the communicator device 60 can be provided at low cost.

Also, if the communicator device 60 does not receive a selected message from the receiver device 70, the communicator device 60 presents an activity message acquired by the activity acquisition unit 41 as the generated message, and thus a receiver who does not have the receiver device 70 can be presented with a message similar to that in conventional technology based on only the communicator emotion.

### Third Embodiment

In the first embodiment and the second embodiment, the generation unit 43 generates an activity message that indicates a desired activity of the communicator based on an activity message and an abstraction level. However, a configuration is possible in which messages corresponding to abstraction levels are prepared in advance for each activity message registered in the activity database 10, and an activity message indicating a desired activity of the communicator is selected from among the messages.

FIG. 11 is a block diagram showing an example of the configuration of a message presentation device that includes a message generation device according to a third embodiment of the present invention. In this configuration, a message database 80 has been added to the configuration of the message presentation device in the first embodiment. Also, the generation unit 43 includes a selection unit 44.

FIG. 12 is a block diagram showing the configuration of the receiver device 70 in another example of the configuration of the message presentation device that includes the message generation device according to the third embodiment. In this configuration, the message database 80 has been added to the configuration of the receiver device 70 in the second embodiment. Also, the generation unit 43 includes the selection unit 44.

Note that in FIGS. 11 and 12, “message database” is abbreviated as “message DB”.

FIG. 13 is a diagram showing an example of information held in the message database 80. As shown in FIG. 13, the message database 80 holds a message corresponding to each abstraction level for each activity message registered in the activity database 10.

The selection unit 44 included in the generation unit 43 selects a message from the message database 80 based on the activity message acquired by the activity acquisition unit 41 and the abstraction level calculated by the abstraction level calculation unit 42. The generation unit 43 generates the message selected by the selection unit 44 as the message that indicates the desired activity of the communicator.

The message generation device according to the third embodiment described above further includes a message database 80 configured to hold, for each activity message held by the activity database 10, a message for each level of abstraction level calculated by the abstraction level calculation unit 42, wherein the generation unit 43 includes a selection unit 44 configured to select, from among the messages held in the message database 80, a message that corresponds to the activity message acquired by the activity acquisition unit 41 and has an abstraction level corresponding to the abstraction level calculated by the abstraction level calculation unit 42. This eliminates the need to calculate a message based on the desired activity of the communicator and the abstraction level that corresponds to the similarity between the communicator emotion and the receiver emotion, and thus the processing speed can be increased.

### Other Embodiments

In the first to third embodiments described above, examples are described for the case of estimating the emotion of a human being who is the receiver based on vocalization information or a face image, but the present invention is not limited to this. For example, there are various proposals for techniques for estimating human emotions based on various types of information such as speech content from a receiver acquired by a microphone and biometric information such as a heart rate acquired by a biometric sensor, such as in JP 2014-18645A and JP 2016-106689A.

Also, in the operations described in the first to third embodiments, communication between a dog and a person is described as an example, but the present invention is not limited to this application. Various embodiments are also applicable to communication with a communicator who cannot express emotions as words, such as communication between a person and another type of pet such as a cat or a bird, and communication between a human infant and a parent.

The above embodiments can also be applied to communication between a communicator who can express emotions as words and a receiver. In this case, the message generation device can receive a message from the communicator and a receiver emotion as input, and can change the generated wording in accordance with the receiver emotion without changing the intention of the communicator’s message. For example, in message generation, in the case where the communicator message is “Let’s go out to eat!”, if the receiver emotion “sad” is received as input, “Let’s go out to eat!” can be changed to “Cheer up! Let’s go out to eat!”, whereas if the receiver emotion “angry” is received as input, “Let’s go out to eat!” can be changed to “Would you like to go out to eat?”

Also, in the first to third embodiments, the abstraction level is set in two levels, but the present invention is not limited to this. If the distance between the emotion vector of the communicator emotion and the emotion vector of the receiver emotion is divided into more categories than simply the two categories similar/dissimilar when making a determination, it is possible to calculate the abstraction level in three or more levels, and correspondingly generate and present three or more types of messages for each activity message.

Also, in the operations described in the first to third embodiments, emotion vectors are used to calculate the similarity between the emotions of the communicator and the receiver, but the similarity between the emotions of the communicator and the receiver may be calculated using another indicator.

Also, although the emotion vectors are defined in Russell’s circumplex model of affect, the emotion vectors may be defined using another emotion model.

Also, in the first to third embodiments described above, the abstraction level is raised or lowered according to the similarity between the emotions of the two parties, but if the number of options can be increased without going outside the scope of the desired activity of the communicator, a different technique may be adopted as the technique for raising or lowering the abstraction level.

Also, in the first to third embodiments, the emotion vector of the communicator emotion is calculated based on the activity message. However, an emotion vector may be calculated in advance for each message registered in the activity database 10, and stored in association with the message in the activity database 10.

Also, the sequences of the processing steps shown in the flowcharts of FIGS. 3, 10A, and 10B are merely examples, and the present invention is not limited to these sequences. For example, in FIG. 3, step S5 for acquiring receiver information may be performed between steps S1 and S6. Also, if the processor 101 is capable of performing parallel processing, the processing of step S5 may be executed in parallel with the processing of steps S2 to S4. In this way, the time at which a processing step is performed may be changed as long as there is no conflict with preceding or subsequent processing steps.

Also, some of the functions of the information processing device that constitutes the message generation device or the message presentation device may be constituted by a server device on the network 400. For example, the activity database 10 and the message generation unit 40 can be provided in the server device.

Also, all the functions of the message generation device or the message presentation device may be provided in the server device. In this case, if the function of collecting communicator information and receiver information and the function of outputting a generated message are provided as skills, a smart speaker connected to the network 400 can be presented to the receiver as if it were a message presentation device. For example, a smart speaker having only a microphone and a speaker as a user interface can transmit vocalization information from the communicator and the receiver to the server device via the network 400, receive a generated message from the server device via the network 400, and output corresponding audio using the speaker. As another example, a smart speaker having a camera and a display as a user interface can transmit vocalization information and face image information regarding a receiver to the server device via the network 400, receive a generated message from the server device via the network 400, and output corresponding audio using the speaker, or displaying the message using the display.

Also, the techniques described in the above embodiments can be realized by a program (software means) that can be executed by a computer, and can be stored on a recording medium such as a magnetic disk (floppy (registered trademark) disk, hard disk, etc.) an optical disk (CD-ROM, DVD, MO, etc.), or a semiconductor memory (ROM, RAM, flash memory, etc.), or be transmitted and distributed via a communication medium. Note that the program stored on a medium can also be a setting program for configuring, in a computer, the software means (including not only an execution program but also a table or a data structure) to be executed by the computer. A computer that realizes this device reads the program recorded on the recording medium, or constructs the software means using the setting program in some cases, and executes the above-described processing by performing operations under control of the software means. Note that the recording medium referred to in the present specification is not limited to being for distribution, and includes storage media such as a magnetic disk or a semiconductor memory provided in a computer or in a device connected via a network.

In other words, the present invention is not limited to the above embodiments, and can be modified in various ways at the implementation stage without departing from the gist of the invention. Also, the embodiments may be carried out in combination as appropriate, in which case a combined effect can be obtained. Moreover, inventions at various stages are encompassed in the above-described embodiments, and various inventions can be extracted from appropriate combinations of the disclosed constituent elements.

[Reference Signs List]
10 Activity database (activity DB)
20 Communicator information acquisition unit
30 Receiver information acquisition unit
40 Message generation unit
41 Activity acquisition unit
42 Abstraction level calculation unit
43 Generation unit
44 Selection unit
50 Message presentation unit
60 Communicator device
61 Communicator communication unit
70 Receiver device
71 Receiver communication unit
80 Message database (message DB)
101, 601 Processor
102, 602 Program memory
103 Data memory
1031, 6031 Activity database storage unit (activity DB storage unit)
1032, 6032 Temporary storage unit
1033, 6033 Presentation information storage unit
104, 604 Communication interface
105, 605 Input/output interface (input/output IF)
106, 606 Bus
107, 607 Key input unit
108, 608 Speaker
109, 609 Display unit
110, 610 Microphone (MIC)
111, 611 Camera
200 Wireless microphone (MIC)
300 Sensor group
400 Network (NW)

1. A message generation device comprising:
a communicator information acquisition unit configured to acquire communicator information for estimating an emotion of a communicator;
a receiver information acquisition unit configured to acquire receiver information for estimating an emotion of a receiver who is to receive a message from the communicator; and
a message generation unit configured to generate a message indicating an activity that corresponds to the emotion of the communicator that was estimated based on the communicator information acquired by the communicator information acquisition unit,
wherein in a case where the emotion of the communicator estimated based on the communicator information acquired by the communicator information acquisition unit is similar to the emotion of the receiver estimated based on the receiver information acquired by the receiver information acquisition unit, the message generation unit generates a message that specifically indicates the activity, as the message indicating the activity, and
in a case where the estimated emotion of the communicator and the estimated emotion of the receiver are dissimilar, the message generation unit generates a message that conceptually indicates the activity, as the message indicating the activity.

2. The message generation device according to claim 1, further comprising:
an activity database storage unit configured to hold a plurality of activity messages each indicating an activity desired by the communicator in correspondence with a communicator emotion,
wherein the message generation unit includes:
an activity acquisition unit configured to estimate the emotion of the communicator based on the communicator information acquired by the communicator information acquisition unit, and acquire, from the activity database, an activity message indicating an activity that corresponds to the estimated emotion of the communicator;
an abstraction level calculation unit configured to estimate the emotion of the receiver based on the receiver information acquired by the receiver information acquisition unit, and calculate an abstraction level of a message to be generated, in accordance with similarity between the estimated emotion of the receiver and the emotion of the communicator estimated by the activity acquisition unit; and
a generation unit configured to generate a message that corresponds to the activity message acquired by the activity acquisition unit, based on the abstraction level generated by the abstraction level calculation unit.

3. The message generation device according to claim 2,
wherein the abstraction level calculation unit converts the emotion of the communicator estimated by the activity acquisition unit into a communicator emotion vector, converts the emotion of the receiver estimated based on the receiver information into a receiver emotion vector, and uses distance between the communicator emotion vector and the receiver emotion vector as similarity between the emotion of the communicator and the emotion of the receiver.

4. The message generation device according to claim 3,
wherein the abstraction level calculation unit calculates an inner product of the communicator emotion vector and the receiver emotion vector,
in a case where the inner product is -1 or more and less than 0, the abstraction level calculation unit determines that the emotion of the communicator and the emotion of the receiver are dissimilar and raises the abstraction level by one level, and
in a case where the inner product is 0 or more and 1 or less, the abstraction level calculation unit determines that the emotion of the communicator and the emotion of the receiver are similar and lowers the abstraction level by one level.

5. The message generation device according to claim 4,
wherein based on the activity message acquired by the activity acquisition unit and the abstraction level calculated by the abstraction level calculation unit, the generation unit generates a message indicating a more specific concept of the activity message as the message that specifically indicates the activity, or generates a message indicating a broader concept of the activity message as the message that conceptually indicates the activity.

6. The message generation device according to claim 4, further comprising:
a message database configured to hold, for each activity message held by the activity database, a message for each level of abstraction level calculated by the abstraction level calculation unit,
wherein the generation unit includes a selection unit configured to select, from among the messages held in the message database, a message that corresponds to the activity message acquired by the activity acquisition unit and has an abstraction level corresponding to the abstraction level calculated by the abstraction level calculation unit.

7. The message generation device according to claim 3,
wherein the communicator emotion vector and the receiver emotion vector are each a vector in Russel’s circumplex model of affect in which emotions are mapped in a two-dimensional space defined by a valence axis and an arousal axis.

8. The message generation device according to claim 2,
wherein the message generation device includes a communicator device in possession of the communicator and a receiver device in possession of the receiver, and
the receiver device includes at least the abstraction level calculation unit and the generation unit of the message generation unit.

9. A message presentation device comprising:
the message generation device according to claim 1; and
a message presentation unit configured to present, to the receiver, the message generated by the message generation unit of the message generation device.

10. A message generation method in a message generation device that includes a processor and generates a message indicating an activity that corresponds to an emotion of a communicator, the message generation method comprising:
acquiring communicator information for estimating the emotion of the communicator, by the processor;
estimating the emotion of the communicator based on the acquired communicator information, by the processor;
acquiring receiver information for estimating an emotion of a receiver who is to receive a message from the communicator, by the processor;
estimating the emotion of the receiver based on the acquired receiver information, by the processor;
generating a message that specifically indicates the activity corresponding to the emotion of the communicator, in a case where the estimated emotion of the communicator and the estimated emotion of the receiver are similar, by the processor; and
generating a message that conceptually indicates the activity corresponding to the emotion of the communicator, in a case where the estimated emotion of the communicator and the estimated emotion of the receiver are dissimilar, by the processor.

11. A non-transitory computer-readable medium having computer-executable instructions that, upon execution of the instructions by a processor of a computer, cause the computer to function as the message generation device according to claim 1.
